(19) United States
(12) Patent Application Publication
(10) Pub. No.: US 2006/0061642 A1
(43) Pub. Date: Mar. 23, 2006

(54) Ink jet recording apparatus and ink jet recording method

(75) Inventor: Hiroyuki Ueki, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/066,631

(22) Filed: Feb. 25, 2005

(30) Foreign Application Priority Data
Sep. 22, 2004 (JP) 2004-276160

(51) Int. Cl. B41J 2/01

(52) U.S. Cl. 347/101

(57) ABSTRACT

An ink jet recording apparatus that includes a recording head that causes printing liquid to impact on a recording medium, and a liquid absorbing mechanism that absorbs excess liquid of the printing liquid remaining on the recording medium after the printing liquid is impacted on the recording medium by means of the recording head, wherein the liquid absorbing mechanism makes a hydrophobic porous body come into contact with the printing liquid for the purpose of absorbing the excess liquid of the printing liquid by means of the hydrophobic porous body.

### CROSS-REFERENCE TO RELATED APPLICATION

This application claims priority under 35 USC 119 from Japanese Patent Application, No. 2004-276160, the disclosure of which is incorporated by reference herein.

### BACKGROUND OF THE INVENTION

1. Field of the Invention

The present invention relates to an ink jet recording apparatus that ejects (impacts) printing liquid (ink or treating liquid) from a recording head onto a recording medium for recording, and to an ink jet recording method.

2. Description of the Related Art

Recently, the spread of color documents in offices has been remarkable, and various output instruments therefore have been suggested. Specifically, inexpensive ink jet systems that allow for miniaturization are being used for various output instruments.

A recording head used for an ink jet system has energy generating unit, energy converting unit for converting the energy generated by the energy generating unit to ink ejecting force, an ink ejection orifice from which ink droplets are ejected by the ink ejecting force, and an ink feeding pathway communicating with the ink ejection orifice for feeding ink. Examples of the energy generating unit may include unit using an electromechanical converter such as a piezo element, or unit for heating ink using an electric heat converting element comprising a heat generating resistor to form air bubbles and for ejecting ink droplets by the generation of the air bubbles.

In an ink jet system, since ink is mainly composed of liquid components, when droplets of ink remain on a recording medium after the droplets impact on the recording medium, the ink offsets to another recording medium, or more ink than necessary is absorbed into the recording medium to generate curl or cockle, thereby making paper transport difficult and also decreasing printing image quality. Additionally, if an impermeable medium is used as a recording medium, excess liquid disturbs an image due to permeation of extremely little ink into the recording medium and also due to a lack of fixation of ink droplets.

As such, many approaches have been proposed that include the conduct of heating, ventilation, etc. for rapid drying after ink is impacted upon a recording medium (paper sheet). These approaches, however, cause concern about a large amount of electric power consumption and the enlargement of an apparatus. On the other hand, while there is a method that involves absorbing the excess liquid of ink remaining on a recording medium by means of absorbent paper, this method is unrealistic because coloring components of ink may be absorbed as well.

Thus, for instance, a process has been proposed in which ink is absorbed with a water absorptive (hydrophilic) resin after ink is impacted on a recording medium (for example, see Japanese Patent Application Laid-Open (JP-A) No. 5-96720, etc.).

The above proposal, however, involves absorbing the excess liquid of an ink by means of a water absorptive resin, and thus the water absorptive resin is gelled by the excess liquid, creating a problem in that the gel adheres to a recording medium or disturbs an image.

### SUMMARY OF THE INVENTION

A first aspect of the present invention is to provide an ink jet recording apparatus comprising:

a recording head that causes printing liquid to impact on a recording medium, and a liquid absorbing mechanism that absorbs excess liquid of the printing liquid remaining on the recording medium after the printing liquid is impacted on the recording medium by means of the recording head, wherein the liquid absorbing mechanism makes a hydrophobic porous body come into contact with the printing liquid for the purpose of absorbing the excess liquid of the printing liquid by means of the hydrophobic porous body.

A second aspect of the invention is to provide an ink jet recording method comprising:

causing a recording head to impact printing liquid upon a recording medium; and absorbing excess liquid of the printing liquid remaining on the recording medium by means of a liquid absorbing mechanism,

wherein the liquid absorbing mechanism makes a hydrophobic porous body come into contact with the printing liquid for the purpose of absorbing the excess liquid of the printing liquid by means of the hydrophobic porous body.

### BRIEF DESCRIPTION OF THE DRAWINGS

FIG. 1 is a schematic block diagram of an ink jet recording apparatus according to an embodiment of the invention.

FIG. 2 is illustrative of a schematic block diagram of a liquid absorbing device in an ink jet recording apparatus according to an embodiment of the invention.

FIG. 3 is illustrative of a perspective view of a liquid absorbing device in an ink jet recording apparatus according to an embodiment of the invention.

FIG. 4 is another example of a schematic block diagram of a liquid absorbing device in an ink jet recording apparatus according to an embodiment of the invention.

FIG. 5 is yet another example of a schematic block diagram of a liquid absorbing device in an ink jet recording apparatus according to an embodiment of the invention.

FIG. 6 is still another example of a schematic block diagram of a liquid absorbing device in an ink jet recording apparatus according to an embodiment of the invention.

FIG. 7 is illustrative of a schematic block diagram of a recording head in an ink jet recording apparatus according to an embodiment of the invention.

### DETAILED DESCRIPTION OF THE INVENTION

The above problem can be solved by the following means. In other words, an ink jet recording apparatus of the invention comprises a recording head that causes printing liquid to impact on a recording medium, and a liquid absorbing mechanism that absorbs the excess liquid of the printing liquids remaining on the recording medium after the printing liquid are impacted on the recording medium by means of the recording head; the liquid absorbing mechanism characteristically makes a hydrophobic porous body come into contact with the printing liquid for the purpose of absorbing the excess liquid of the printing liquid by the hydrophobic porous body.

An ink jet recording apparatus of the invention includes as a liquid absorbing mechanism a porous body absorbs excess liquid with the capillary attraction of the porous body. The porous body is hydrophobic, and therefore is not gelled even though absorbing excess liquid, thereby preventing the adherence to a recording medium or disturbance of an image. As such, the porous body can reliably absorb the excess liquid of the printing liquid that impact on the recording medium, and can sufficiently improve offset of the printing liquids, curl, cockle, and drying properties to obtain a good image.

In an ink jet recording apparatus of the invention, the pore diameter of the hydrophobic porous body is suitably from 10 to 100 nm. This structure reliably absorbs the excess liquid of printing liquid and prevents the absorption and removal of coloring material in the printing liquid.

The amount of absorption of the above hydrophobic porous body is suitably from 1 to 100 ml/g. This structure enables sufficient absorption of the excess liquid of printing liquid.

The aforementioned hydrophobic porous body suitably comprises a polymer made from a water-insoluble monomer. This can simply compose a hydrophobic porous body.

Suitably, in an ink jet recording apparatus of the invention, the above liquid absorbing mechanism has an absorber that has a surface layer making contact with the aforementioned excess liquid and the above surface layer includes the above-described hydrophobic porous body. Also, the above surface layer may comprise a laminar body of the above hydrophobic porous body, or may comprise a resin layer in the surface of which a particular body of the above hydrophobic porous body is embedded. The average particle diameter of the above particular, hydrophobic porous body is suitably from 1 to 100 μm. This structure allows the hydrophobic porous body to absorb the excess liquid of printing liquid; the structure is a simple liquid absorbing mechanism.

In an ink jet recording apparatus of the invention, the above-described liquid absorbing mechanism suitably include both a spraying unit for spraying the above granular hydrophobic porous body on the aforementioned recording medium and a removal unit for removing the above granular hydrophobic porous body sprayed on the above recording medium. The average particle diameter of the aforementioned granular hydrophobic porous body is suitably from 1 to 100 μm. This structure allows the hydrophobic porous body to absorb the excess liquid of printing liquid; the structure is a simple liquid absorbing mechanism. In particular, the hydrophobic porous body absorbs the extra liquid without gelation and without adherence on a recording medium, so it can sufficiently absorb the excess liquid and readily be removed, thereby preventing the disturbance of an image as well.

In an ink jet recording apparatus of the invention, the aforementioned recording medium is suitably a normal paper sheet, or an impermeable medium. In the invention, even when a normal paper sheet and also an impermeable medium that is extremely poor in permeability of the extra liquid are used, the hydrophobic porous body can reliably absorb the excess liquid of printing liquid that are impacted on a recording medium, thereby being capable of obtaining a good image.

On the other hand, an ink jet recording method of the invention comprises a step of causing a recording head to impact printing liquid upon a recording medium and a step of absorbing the excess liquid of the printing liquid remaining on the recording medium; the liquid absorbing mechanism characteristically makes a hydrophobic porous body come into contact with the printing liquids for the purpose of absorbing the excess liquid of the printing liquid by the hydrophobic porous body.

An ink jet recording method of the invention, similar to the above ink jet recording apparatus, can reliably absorb the excess liquid of printing liquids that impact on a recording medium, and can sufficiently improve offset of the printing liquid, curl, cockle, and drying properties to obtain a good image.

In addition, a suitable form of an ink jet recording method of the invention is as for the above ink jet recording apparatus of the invention.

The present invention has been made in view of the above circumstances and provides an ink jet recording apparatus which can reliably absorb the excess liquid of printing liquid (ink or treating liquid) that impacts on a recording medium, and which can sufficiently improve offset of printing liquids, curl, cockle, and drying properties to obtain a good image, and an ink jet recording method.

An ink jet recording apparatus of the invention will be set forth in detail in reference to drawings hereinafter. An ink jet recording method of the invention will also be described along with an ink jet recording apparatus of the invention. Additionally, the members substantially having the same function will be described by use of the same symbols throughout all the drawings. In all the drawings, P indicates a paper sheet (recording medium).

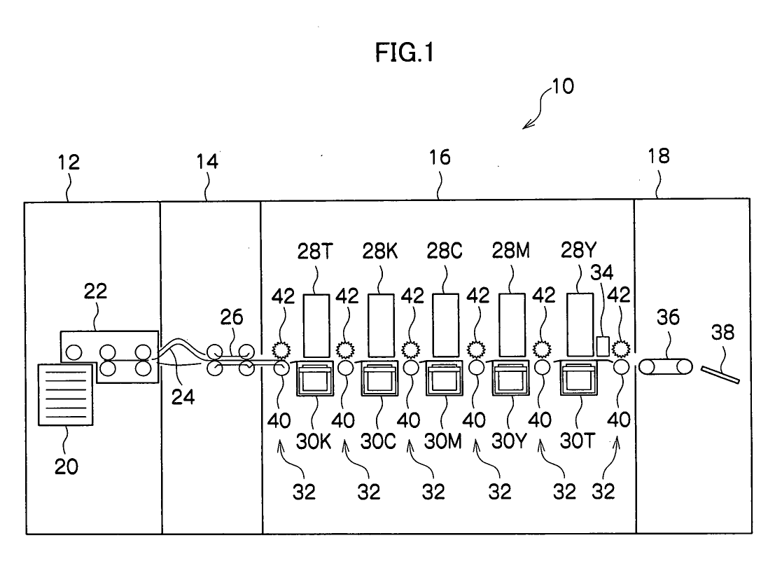

FIG. 1 is a schematic view of an ink jet recording device according to an embodiment of the invention.

As shown in FIG. 1, the ink jet recording device 10 basically includes a paper feeding portion 12 for feeding paper, a registration adjusting portion 14 for adjusting the position of the paper, a recording portion 16 for forming an image on paper (image recording medium) using printing liquid (ink or treating liquid), and a paper ejecting portion 18 for ejecting paper on which an image has been formed by the recording portion 16.

The paper feeding portion 12 basically includes a stacker 20 in which paper sheets are stocked in a pile and a conveying device 22 for sheet-feeding a sheet of paper from the stacker 20 and conveying the sheet to the registration adjusting portion 14.

The registration adjusting portion 14 has a loop forming portion 24 and a guide member 26 for controlling the position of the paper. The paper passes the portion, whereby skew of the paper is corrected by utilizing elasticity of the paper and conveying timing is controlled, and the paper enters into the recording portion 16.

The recording portion 16 basically includes recording heads 28 for depositing printing liquid (ink or treating liquid) on the paper (recording medium) for forming an image, maintenance devices 30 provided facing nozzle surfaces of the recording heads 28 and conveying means 32 for conveying paper between the recording heads 28 and the maintenance devices 30. The recording heads 28 can provide full-color printing by printing with treating liquid (T), black (K), cyan (C), magenta (M) and yellow (Y) ink in this order from the upstream side in the conveying direction. The order, from ink to treating liquid, is allowable, but is preferable for from treating liquid to ink. Where necessary, the recording head for each color is identified by assigning reference symbols T, K, C, M and Y to the reference numeral (as recording heads 28t, 28K, 28C, 28M and 28Y). Hereinafter, the same is also applied to other members (maintenance devices 30T to 30Y).

Near the outlet of a recording portion 16 and thus downstream of a recording head 28Y, a liquid absorbing device 34 is provided that absorbs the extra liquid of printing liquid (ink or treating liquid) that are impacted on a paper sheet from each of recording heads 28K to 28T. This liquid absorbing device 34 absorbs the excess liquid of the ink on the paper sheet after the ink (containing the treating liquid) is impacted on the paper sheet in sequence from each of recording heads 28T to 28Y.

Each recording head 28 and each maintaining device 30 is unified and the recording heads 28 can be configured to be separated from the maintaining devices 30 in the paper sheet transport path. Thus, when a paper sheet is jammed, the jammed sheet can readily be taken out.

In a paper sheet-discharging portion 18, a paper sheet on which an image is formed in the recording portion 16 is placed in a tray 38 through a paper sheet-discharging belt 36.

Printing liquid utilizes a two-liquid type ink set containing both an ink containing at least a pigment, a water-soluble solvent and water, and a treating liquid coagulating the pigment of the ink. In the embodiment, as described above, the recording head 28T discharges a treating liquid and the recording heads 28K to 28Y expel full color inks of a black ink, a cyan ink, a magenta ink, and a yellow ink. The details will be set forth later. Additionally, in the embodiment, the form will be described that uses a two-liquid type ink set; however, the form is not limited thereto and a one-liquid type ink set may be used.

Now, the liquid absorbing device 34 will be described.

The liquid absorbing device 34 is a device that causes a hydrophobic porous body to make contact with the aforementioned ink and absorbs the excess liquid of the above ink by means of the aforementioned hydrophobic porous body First, the hydrophobic porous body will be described.

The pore diameter of the hydrophobic porous body is preferably from 10 to 100 nm, more preferably from 15 to 90 nm, still more from 20 to 80 nm. Rendering the pour diameter within the above range reliably absorbs excess liquid of an ink, thereby preventing absorption and removal of coloring material in the ink.

The pore diameter is a value that is determined by the observation under a scanning electron microscope.

The hydrophobic porous body exhibits the amount of absorption of the excess liquid that is preferably from 1 to 100 ml/g, more preferably from 1 to 50, still more preferably from 1 to 10. Rendering the amount of absorption of the extra liquid within the above range can make excess liquid of an ink be sufficiently absorbed.

The amount of absorption of the excess liquid is a value determined by a method that sets to the end point a point at which a hydrophobic porous body is tempered while an ink without coloring material is dropped into the hydrophobic porous body, so that the whole can spirally be formed with a net spatula.

Other suitable properties of the hydrophobic porous body include a specific surface area being preferably from 1 to 200 m²/g, more preferably from 3 to 150 m²/g, still more preferably from 5 to 100 m²/g. Rendering the specific surface area within the above range makes it possible to rapidly and sufficiently absorb the excess liquid of an ink.

The hydrophobic porous body is used in the form of a layer or particles; when it is of particles, the average particle diameter is from 1 to 100 μm, more preferably from 3 to 80 μm, yet more preferably from 5 to 50 μm.

The composition materials of the hydrophobic porous body include polymers having water-insoluble (oil-soluble) monomer material as starting material such as vinyl-based resins (e.g., methyl polymathacrylate, polystyrene, fluorine resin), and polyolefin-based resins (e.g., polyethylene, polypropylene).

In the water-insoluble monomers, examples of vinyl-based monomers include styrene-based monomers (e.g., styrene, p-methylstyrene, p-tert-butylstyrene), acrylic acid ester-based monomers (ethyl acrylate, methyl acrylate, lauryl acrylate, butyl acrylate, methyl methacrylate, ethyl methacrylate, butyl methacrylate, isobutyl methacrylate, phenyl methacrylate, benzyl methacrylate, lauryl methacrylate). The polyolefin-based monomers include ethylene monomer and polypropylene monomer. Additionally, the hydrophobic porous body may be composed of a single polymer of a water-insoluble monomer, or may be composed of a copolymer.

The hydrophobic porous body can be obtained by a procedure that includes, for example, dissolving a non-polymerizable solvent, i.e., a perforating agent, in a water-insoluble monomer in the presence of a crosslinker for polymerization, and after the polymerization conducting washing and drying steps for the purpose of removal of the water and the perforating agent. Obtaining a hydrophobic porous body in a layer form may include, for example, forming a layer after the completion of polymerization and carrying out washing and drying steps. Also, obtainment of a granular hydrophobic porous body may conduct, for example, water-based suspension polymerization. The process of producing a hydrophobic porous body can be carried out, for example, in accordance to JP-A No. 61-69816, 63-316715, 2-290804, or 2003-283612.

Next, the liquid absorbing device 34 will be described that utilizes a hydrophobic porous body. Examples of the liquid absorbing device 34 that may be adopted include the roller system, the belt system, and the web system. The adoption of the systems can efficiently absorb the excess liquid of printing liquids with a simple structure. A hydrophobic porous body is utilized for the surface absorption layer (surface layer) that makes contact with the excess liquid of printing liquids in the constitution members (a roller, a belt, and a web).

Specifically, for example, the surface absorption layer may be comprised of a laminar hydrophobic porous body layer, or may be comprised of a resin layer having a granular hydrophobic porous body embedded in the surface thereof. Both of the surface absorption layers utilize the capillary attraction of the hydrophobic porous body exposed to the surface to absorb the excess liquid of an ink. When the constitution members (a roller, a belt and a web) in the liquid absorbing device 34 has a surface absorption layer comprised of a laminar hydrophobic porous body layer, the entire layer can absorb the excess liquid, whereby the surface layer may be made of a multilayer structure containing other layers such as an absorbing body layer; when the surface absorption layer is comprised of a resin layer having a granular hydrophobic porous body embedded in the surface thereof, it may be comprised of a single layer structure since only the granular hydrophobic porous body embedded in the surface thereof absorbs the excess liquid. In addition, the resin layer may also be comprised of a hydrophobic resin such as a vinyl-based resin or a polyolefin-based resin, similar to a porous body.

The hydrophobic porous body may be subjected to hydrophilic treatment for conduct of the initial rapid absorption in contact with ink droplets.

The liquid absorbing device 34 will be described for its specific construction hereinafter. Additionally, the constitution members (a roller, a belt and a web) in the liquid absorbing device 34 as will be described below is a laminated structure that uses a laminar hydrophobic porous body layer as a surface absorption layer.

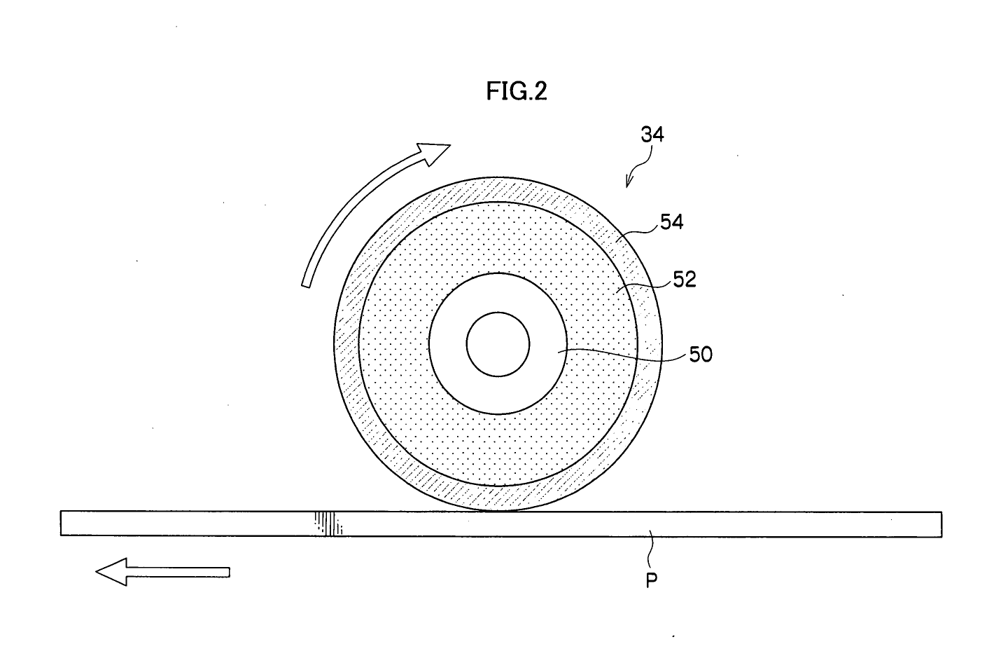

Examples of the liquid absorbing device 34 include the liquid absorbing device 34 of a roll mode comprised of a liquid absorbing roll coated with an absorbing body layer 52 and a surface absorption layer 54 in order on the outer periphery of a metal shaft 50, as shown in FIG. 2.

The surface absorption layer 54 is a member that comprises the surface in contact with the excess liquid of printing liquid and comprised of the above laminar hydrophobic porous body layer. The thickness of the surface absorption layer 54 is preferably from 0.01 to 10 mm, more preferably from 0.1 to 1.5 mm.

The absorbing body layer 52 absorbs the excess liquid in contact with the surface absorption layer 54 via the surface absorption layer 54, and is suitably made of a porous body or a fiber body, from the standpoint of efficient absorption of the excess liquid. Specific examples of the constitution materials include natural fibers and chemical fibers such as wool, cotton, silk, polyester, polyamide, polyacrylonitrile, polypropylene, cellulose, urethane and melamine, or porous bodies. To these materials may be added an organic or inorganic filler for the regulation of the strength or surface states.

The absorbing body layer 52 may have a composition of increasing fiber density or increasing pore density from the outside to the inside. This can move the excess liquid absorbed through the surface absorption layer 54 to the inside (metal shaft 50 side) by capillarity.

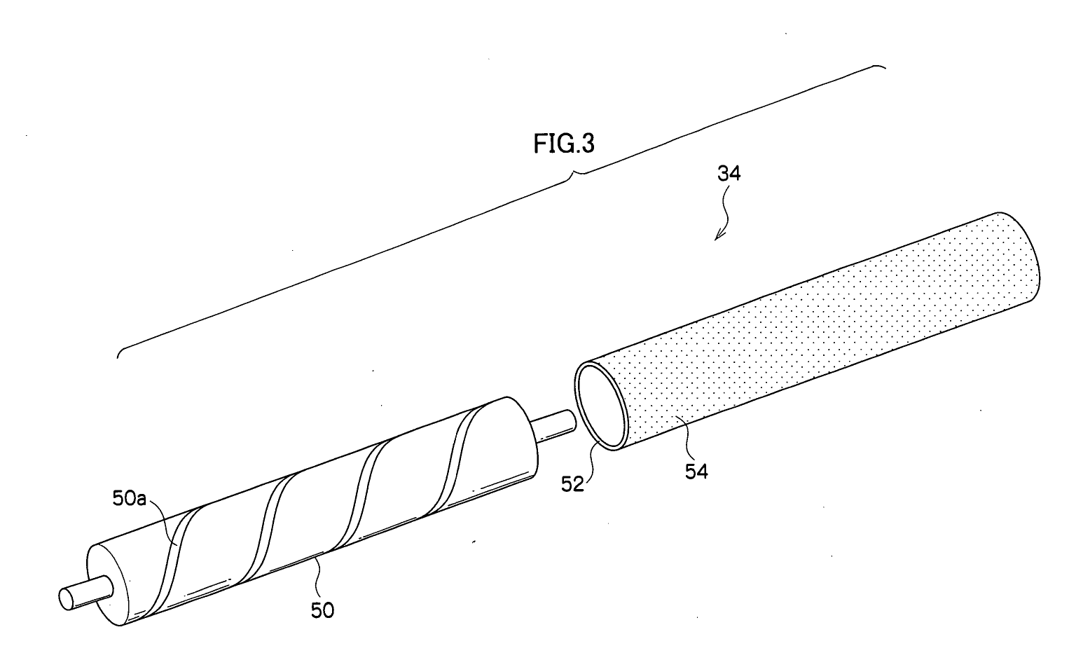

The metal shaft 50 is comprised of, for example, stainless steel and aluminum. On the outer periphery of the metal shaft 50, a spiral groove 50a is provided, as illustrated in FIG. 3.

The liquid absorbing body of the roll mode of the embodiment causes the surface of the surface absorption layer 54 to make contact with the excess liquid of printing liquid remaining on a paper sheet while the liquid absorbing roll is made to be rotated, thereby absorbing the excess liquid by means of the absorbing body layer 52 via the surface absorption layer 54. The excess liquid absorbed in the liquid absorbing body layer 52 reaches the groove 50a of the metal shaft 50, which rotates the metal shaft 50, thereby traveling the excess liquid to one end through the groove 50a, leading to the collection of the liquid in a collection vessel (not shown). In this manner, absorbed is the excess liquid of printing liquid on a paper sheet (recording medium).

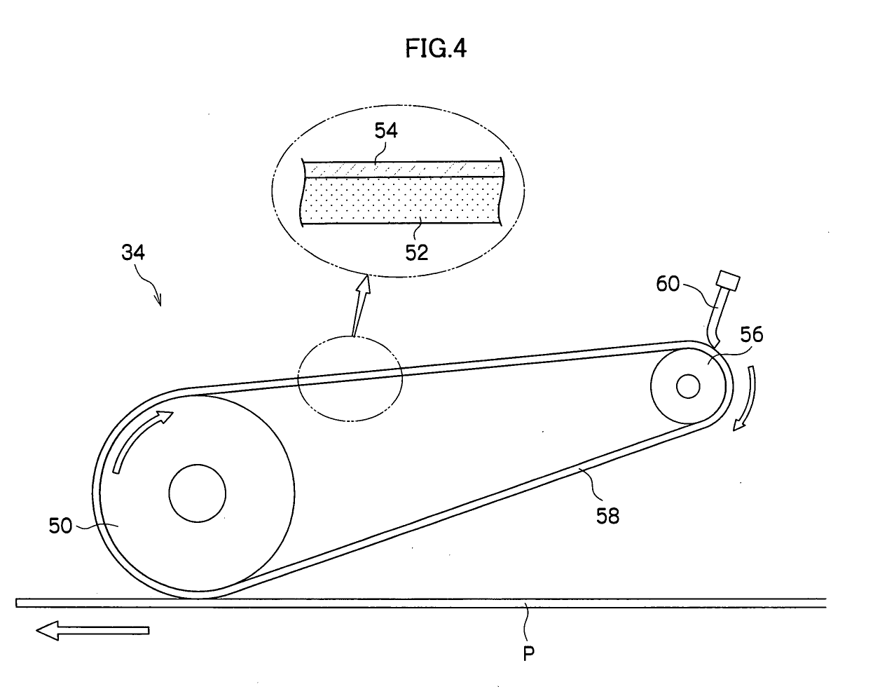

Other forms of the liquid absorbing device 34 include an endless belt mode liquid absorbing device 34 comprised of the metal shaft 50, a stretch-hanging shaft 56, a liquid absorbing endless belt 58 stretch-hung between both the shafts, and a blade 60 that cleans the liquid absorbing endless belt surface, as indicated in FIG. 4.

The layer construction of the liquid absorbing endless belt 58 is made up of lamination of the absorbing body layer 52 and the surface absorption layer 54 from the inner periphery side. These layers can be the same construction as in the above roll mode. The metal shaft 50 has the spiral groove 50a on the outer periphery thereof. A similar spiral groove is provided in the outer periphery of the stretch-hanging shaft 56, although not shown.

The endless belt mode liquid absorbing device 34 of the form causes the endless belt 58 to be rotated to the accompaniment of the rotation of the metal shaft 50 or the stretch-hanging shaft 56, thereby absorbing the excess liquid of printing liquid on a paper sheet (recording medium) as in the above roll mode liquid absorbing device 34.

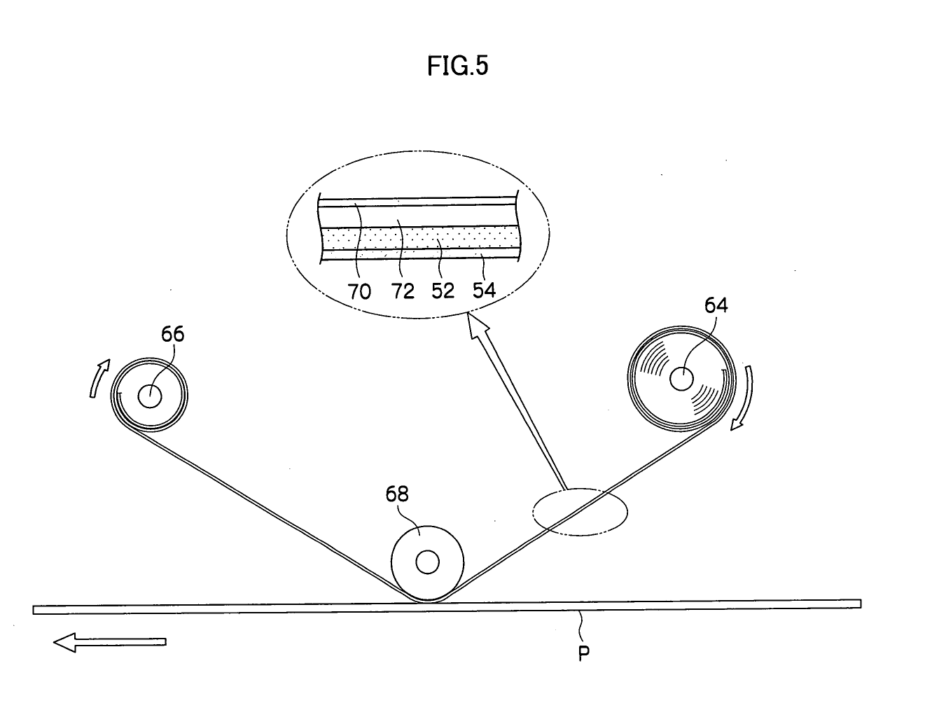

Other forms of the liquid absorbing device 34, as shown in FIG. 5, include a liquid absorbing device of a web mode comprised of a web 62 for absorbing a liquid, a roll 64 on which a web 62 is wound, a winding roll 66 that winds off the web 62 wound on the roll 64 at one end, and a pressing roll 68 that presses a web against a paper sheet from the winding-off surface side.

The layer construction of the liquid absorbing web 62 has a construction in which from the winding-off surface side of the roll 64 are laminated a liquid permeation preventing layer 70, a liquid holding layer 72, the absorbing body 52 and the surface absorption layer 54; these can be made to be constructed as in the above roll mode. The above roll mode, however, is provided with an excess liquid collecting mechanism by mean of the spiral groove 50a disposed in the metal shaft 50, while it is not provided in the form, so the liquid holding layer 72 is placed in such a way that it is sandwiched between the liquid permeation preventing layer 70 and the absorbing body layer 52.

Preferable examples of the material of the liquid retention layer 72 include hydrophilic polymer powder. Examples of such a water soluble polymer may include starch-type polymers, cellulose-type polymers and synthetic polymers, and specifically include, for example, cross-linked polyacrylic acid salt-type polymers, isobutylene/maleic acid-type polymers, starch/polyacrylic acid salt-type polymers and PVA/polyacrylic acid salt-type polymers.

The material of the liquid permeation preventing layer 70 may be any material so long as it can prevent leaking of the excess liquid held by the liquid retention layer 72 to the winding surface side of the take-up sheet 62. Examples thereof may include polyethylene, polyethylene terephthalate, polypropylene, poly(vinyl chloride) and poly(vinylidene fluoride).

The web mode liquid absorbing device of the form causes the surface of the surface absorption layer 54 to make contact with the excess liquid of printing liquid remaining on a paper sheet by means of the pressing roll 68 while winding the liquid absorbing web 62 by the winding roll 66, whereby the absorbing body layer 52 the excess liquid via the surface absorption layer 54. Then, the excess liquid absorbed in the liquid absorbing body layer 52 reaches the liquid holding layer 72, which keeps the excess liquid for collection. In addition, the excess liquid can be made to be absorbed while the roll 64 winds the wound web 62 off the winding roll 66 again.

Any of the liquid absorbing devices 34 constructed as described above is suitably made to be a construction having an absorbing region corresponding to the maximum paper width of a paper sheet as with the recording heads 28 as will be set forth later. Also, each constituent layer is not necessarily made up of a different member, each constituent may be integrally composed of the same material.

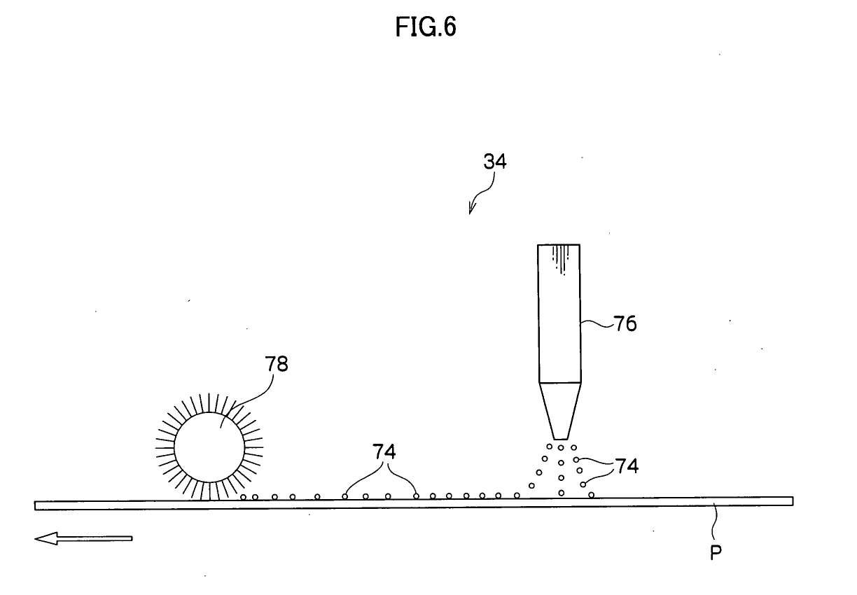

The liquid absorbing devices 34 are not limited to the above constructions, and may include a construction that comprises a particle jetting device 76 (spraying means) that jets granular hydrophobic porous body 74 for its spray on a paper sheet and a brush roll 78 (removing means) that removes the dispersed granular hydrophobic porous body 74, as shown in FIG. 6.

The particle jetting device 76 can be made to be a construction that, for example, ejects granular hydrophobic porous bodies by air pressure. In the form, a form was described in which a particle jetting device is applied as a sprinkling unit; however, the form is not particularly limited thereto as long as a granular hydrophobic porous body can be sprinkled on a paper sheet. For instance, the particle jetting device may also be a system that involves blending granular hydrophobic porous bodies with a powder capable of being charged for charging, and then sprinkling the mixture on a paper sheet by electric field transfer.

The brush roll 78 can be made to be a constitution in which, for example, a natural fiber (for example, silk, cotton), a recycled fiber (for example, rayon), a synthetic fiber (for example, acrylic fiber, polyester fiber, nylon fiber), or the like is implanted in the outer periphery of a cylinder. In the form, a form was described in which the brush roll 78 is applied as a removing unit; however, the form is not particularly limited thereto so long as it has a construction that removes granular hydrophobic porous bodies sprinkled on a paper sheet; the examples may also include a vacuum system that involves removal by suction, or a magnetic system that entails removal by magnetism utilization.

The liquid absorbing device 34 of the form involves printing liquid on a paper sheet, spraying granular hydrophobic porous bodies to make contact with the printing liquid for the purpose of absorbing the excess liquid, and subsequently removing granular hydrophobic porous bodies that has absorbed the excess liquid. At this time, the granular hydrophobic porous bodies is not gelled by absorption of the excess liquid, or adhered on the paper sheet, thereby being capable of readily removing the excess liquid while the excess liquid is sufficiently absorbed, leading to the prevention of disturbance of the image as well.

The granular hydrophobic porous bodies thus removed are also collected, are dried by application of heat or airflow, or the like, and then are capable of being reused.

Next, the recording head 28, the maintaining device 30 and a transporting means 32, which are construction members of the recording portion 16, will be described one by one.

The recording head 28 may be a thermal-type ink jet which transfers ink directly on paper in non-contacting manner, a piezo-type ink jet, a continuous flow-type ink jet or an electrostatic suction-type ink jet.

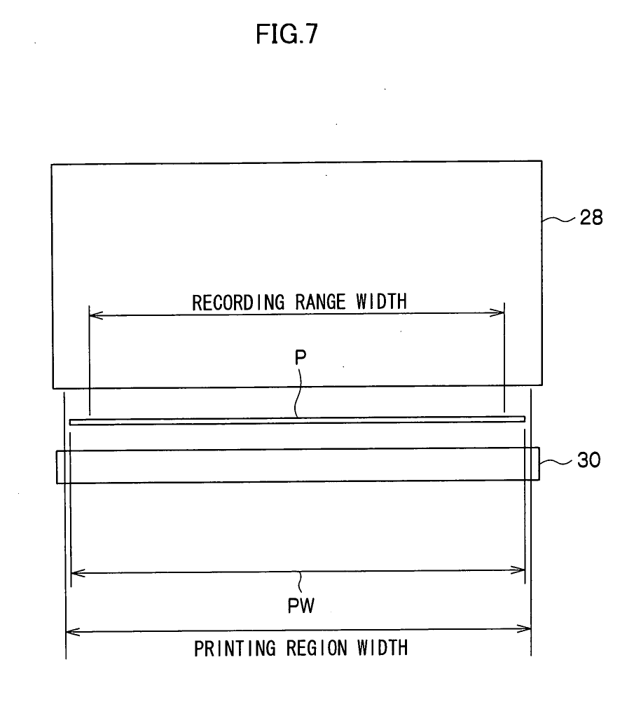

The recording head 28 has a printing region meeting the maximum paper width PW of a paper sheet and can print an image on the entire width of the paper sheet without scanning of the recording head 28, as illustrated in FIG. 7. More specifically, it has a construction in which printing is completed only by one passage of a paper sheet through the downside of the recording head 28.

If the paper has a printing margin, the printing area of the recording head 28 has a width corresponding to (not less than) the width of the recording area obtained by subtracting the printing margin from the maximum paper width (PW).

It is generally preferable that the printing area width of the recording head 28 is larger than the recording area width, because the paper may be conveyed while inclined at a certain angle relative to the conveying direction (skewing) and because marginless printing is sometimes desired.

The recording head 28 may include a monolithic, elongated heads (head chip) in which nozzles are formed in a line through the printing area, but the head preferably has a combination of short heads (head chips, hereinafter referred to as unit recording heads). The unit recording heads (short heads) can be produced in large numbers easily, and it is significantly easier to improve the process yield of the individual short heads than that of the monolithic long head. Accordingly, the recording head 28 constituted by the combination of unit recording heads can be produced at lower cost than that required for the long head.

For example, the recording head 28 may be structured so that printing can be carried out in the printing area continuously, as follows. Unit recording heads in which nozzles are provided in a line on the nozzle surface are attached to two common substrates with the lines of nozzles arranged in line. The substrates are then placed so that the nozzles are placed alternately. In this case, the recording head can be used interchangeably with an inexpensive device (recording head) that is produced in large numbers. Accordingly, the recording head 28 which can print whole width can be provided at low cost.

A commercially available or known serial recording-type ink jet recording head may be used as the unit recording head. The unit recording head may be constituted by only head chips in which ink is supplied by an ink flow pathway provided on each common substrate for the plural head chips. It is preferable that each of the unit recording heads can be replaced.

Alternatively, the recording head 28 may have unit recording heads continuously-arranged in the width direction with the unit recording heads each having nozzles formed to the end portion thereof in the direction in which the nozzles are arranged. It is required that the end portions of the unit recording heads are formed with high precision in order to align the nozzle pitch at the connecting portions of the unit recording heads. However, this structure allows for the greatest reduction in size of the recording head 28.

The arrangement of the nozzles on the unit recording head may be a straight line, but is not limited thereto. For example, nozzles can be aligned in staggered manner.

The maintenance device 30, which is placed opposing the recording head 28, comprises an ink receiving portion in which ink ejected from the recording head 28 at least when printing is not carried out is received, and maintains uniform printing (ejection of ink) property of the recording head 28. Since the maintenance device 30 having ink receiving portion is placed opposing the recording head 28, the ink transferred from the recording head 28 can be housed therein, with certainty, when printing is not carried out.

The recording head 28 requires the conduct of the ejection of printing liquids during non-printing (hereinafter, referred to as dummy jet) for the purpose of initialization of ejection performance in consideration of dryness of printing liquids (particularly, water based ink, solvent ink).

In the case where oily ink or solid ink, which hardly dries, is used, dummy jetting is required for the purpose of initializing the ejection property by eliminating the effect of micro air bubbles generated during printing in the recording head 28 or the effect of printing liquid or micro dust adhered on the surface of the nozzles (printing liquid ejection surface).

The maintenance device 30 (printing liquid receiving portion) houses the printing liquid ejected during dummy jetting, and may include an printing liquid absorbing member so that the housed printing liquid is not scattered. Alternatively, the maintenance device 30 may have a structure in which printing liquid is drained to a drain means provided at another location via an printing liquid permeation member or a tube member.

It is sufficient that the maintenance device 30 has at least the above-mentioned printing liquid receiving function, but the maintenance device 30 may further have other maintenance functions so as to maintain the printing liquid ejecting property. For example, the maintenance device 30 may have a wiper member for cleaning the nozzle surface, or may have a capping function that protects the nozzle surface by tightly adhering to the surface. Alternatively, the maintenance device 30 may have a vacuum function for sucking printing liquid from the nozzles.

It is not necessary for the maintenance device 30 to have functions other than the printing liquid receiving function, for example, the above-mentioned wiping function, capping function, or the like. The recording head, for example, may have a device for such functions (wiping device, capping device, or the like).

The conveying means 32 conveys paper by a means other than electrostatic adsorption (hereinafter referred to as a non-electrostatic adsorption device). Namely, the conveying means 32 is not specifically limited so long as it can convey paper stably at a constant velocity between the recording head 28 and the maintenance device 30. For example, a combination of a conveying roll or a conveying belt and a pressing means can be applied.

In addition, it is preferable that the conveying means 32 is positioned at a position different from that of the recording head 28 in the conveying direction so that the maintenance device 30 can be easily provided at the position opposing the recording head 28.

For example, the conveying means 32 may have a conveying roll 40 that provides driving force to the paper by contacting the rear surface of the paper and urging means (not depicted) that presses the paper towards the conveying roll 40.

This is because, if the electrostatic adsorption device is adopted, electrostatic adsorption may be unstable depending on the thickness of the paper and the material of the paper. On the other hand, the driving force can be transmitted with certainty, irrespective of the thickness or material of the paper, by pressing the paper towards the conveying roll 40 using the urging means, which allows stable conveyance of the paper.

Examples of the urging means include a device in which an urging member is directly contacted with the paper to allow urging, and a device in which an urging member is not contacted directly with the paper. The latter device includes, for example, a device comprising means for blowing air, or the like. This device is excellent, because it does not contact with the printed paper.

On the other hand, as an example of the former device, this embodiment adopts a star wheel 42 including a spring in which urging force is applied by the spring through a shaft (not depicted). Accordingly, the paper is pressed towards the conveying roll 40 by the star wheel 42 elastically urged towards the conveying roll 40 irrespective of the thickness or material of the paper. As a result, driving force is transmitted with certainty from the conveying roll 40, which allows stable conveyance of the paper.

The shape of the star wheel 42 is not specifically limited so long as the area contacting the paper is minimized. The material for the star wheel 42 may be metal or plastic. Preferable examples thereof include an SUS631H material obtained by curing treatment of SUS631H at high temperature. Examples of the production method thereof include, but are not specifically limited to, etching, pressing and laser beam machining.

Accordingly, even though the star wheel 42 contacts the recording surface of the paper, the area contacting the recording surface immediately after transfer of printing liquid can be minimized, whereby the effect on the printing image quality can be minimized.

The pressing force applied on the star wheel 42 urged via a shaft is preferably 49.03325 mN to 294.1995 mN (5 gf to 30 gf), and more preferably 98.0665 mN to 196.133 mN (10 gf to 20 gf). If the pressing force is less than 49.03325 mN (5 gf), the paper cannot be sufficiently urged. On the other hand, if the pressing force is more than 294.1995 mN (30 gf), the paper may be damaged.

In the case where a group of star wheels is constituted by plural star wheels 42, it is preferable that the star wheels are supported by a common shaft, and the interval of the star wheels 42 is preferably not more than 50 mm so that local lifting or deformation can be suppressed.

In the case where the printing area is large, it is preferable to divide the shaft into plural shafts and to support plural star wheels 42 with each shaft. This is because, otherwise, the shaft bends and the star wheels 42 urge the paper unevenly, which leads to failure to suppress local lifting or deformation of the paper.

Any conventionally known conveying roll may be applied as the conveying roll 40. Those having a high surface friction coefficient and excellent antiwearing property are preferred for securely transmitting driving force to the paper. Examples thereof include a rubber roll in which rubber has been coated on the outer peripheral surface of a metal roll and a ceramic roll in which ceramic powder has been coated on the outer peripheral surface of a metal roll.

Next, the printing liquid (ink or treating liquid) will be set forth.

The printing liquid may utilize a color ink containing at least a pigment, a water-soluble solvent and water, and a treating liquid having the function of coagulating the pigment of the ink. In the embodiment, the treating liquid is used separately from an ink, and may be used as an ink (for example, a yellow ink) that is made to contain a pigment. A means (step) of largely coagulating a pigment means that an ink is made to make contact with a treating liquid. In other words, in the embodiment, the means indicates the recording head 28T.

Ink contains at least a pigment, a water-soluble solvent and water. The size of the pigment before a coagulation is preferably 10-200 nm. The size of the coagulated pigments largely coagulated by the treating liquid is 0.5 nm or more. Therefore, high image density is obtained and effective absorption of the excess ink is obtained because the liquid absorbing device hardly absorb pigments.

As pigment, both organic pigment and inorganic pigment can be used. Preferable examples of the black pigment include carbon black pigments such as furnace black, lamp black, acetylene black and channel black.

Specific pigments such as red, green, blue, brown and white, metal gloss pigments such as gold and silver, colorless body pigments and plastic pigments as well as three primary color pigments of black, cyan, magenta and yellow can be used. Alternatively, a newly synthesized pigment for the invention can be used.

For example, Raven 7000, Raven 5750, Raven 5250, Raven 5000 ULTRA II, Raven 3500, Raven 2000, Raven 1500, Raven 1250, Raven 1200, Raven 1190 ULTRA II, Raven 1170, Raven 1080, Raven 1060 (these are manufactured by Colombian Carbon); Regal 400R, Regal 330R, Regal 660R, Mogul L, Monarch 700, Monarch 800, Monarch 880, Monarch 900, Monarch 1000, Monarch 1100, Monarch 1300 and Monarch 1400 Black FW2, Color Black FW2V, Color Black 18, Color Black FW200, Color Black S150, Color Black S160, Color Black S170, Printex 35, Printex U, Printex V, Printex 140U, Printex 140V, Special Black 6, Special Black 5, Special Black 4A and Special Black 4 (these are manufactured by Degussa, Inc.); and No. 25, No. 33, No. 40, No. 47, No. 52, No. 900, No. 2300, MCF-88, MA600, MA7, MA8, MA100 (these are manufactured by Mitsubishi Chemical, Inc.) can be used.

Examples of the cyan pigment may include, but are not limited to, C.I. Pigment Blue 1, C.I. Pigment Blue 2, C.I. Pigment Blue 3, C.I. Pigment Blue 15, C.I. Pigment Blue 15:1, C.I. Pigment Blue 15:3, C.I. Pigment Blue 15:4, C.I. Pigment Blue 16, C.I. Pigment Blue 22 and C.I Pigment Blue 60.

Examples of the magenta pigment may include, but are not limited to, C.I. Pigment Red 5, C.I. Pigment Red 7, C.I. Pigment Red 12, C.I. Pigment Red 48, C.I. Pigment Red 48:1, C.I. Pigment Red 57, C.I. Pigment Red 112, C.I. Pigment Red 122, C.I. Pigment Red 123, C.I. Pigment Red 146, C.I. Pigment Red 168, C.I. Pigment Red 184, and C.I. Pigment Red 202.

Examples of the yellow pigment may include, but are not limited to, C.I. Pigment Yellow 1, C.I. Pigment Yellow 2, C.I. Pigment Yellow 3, C.I. Pigment Yellow 12, C.I. Pigment Yellow 13, C.I. Pigment Yellow 14, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 114, C.I. Pigment Yellow 128, C.I. Pigment Yellow 129, C.I. Pigment Yellow 151, C.I. Pigment Yellow 154.

As pigment, a self-dispersing pigment in water can be used. A self-dispersing pigment is a pigment which is dispersed in water stably without the polymer dispersant due to the many dissolving groups in water on the surface of the pigment. Specifically, for example, a self-dispersing pigment is obtained by the surface reformation treatment such as acid/base treatment, coupling agent treatment, polymer grafting treatment, plasma treatment and oxidation/reduction treatment to the normal pigment.

As the criterion of whether the “self-dispersing pigment in water,” the following criterion was employed. That is, 95 parts by weight of water is added to 5 parts by weight of a pigment and the resulting solution is dispersed by means of an ultrasonic homogenizer and then the resultant dispersed solution is allowed to stand for one day. For the dispersed solutions prior to and subsequent to standing still, determined is the pigment concentration of the dispersed solution of one-third volume from above. When the pigment concentration of a dispersed solution after standing still is 98% or more of the concentration prior to the standing still, the dispersed solution is called a “self-dispersing pigment in water.”

A self-dispersing pigment in water and may be used include CAB-O-JET-200, CAB-O-JET-300, IJXTM 253, IJXTM 266, IJXTM 444, IJXTM 273, and IJXTM 55 (trade names, manufactured by Cabot Corporation), MICROJET BLACK CW-1, and CW2 (trade names, manufactured by Orient Chemical Industries, Ltd.), which are commercially available, in addition to the pigments prepared by surface modifying treatment of the above pigments.

When a self-dispersing pigment in water is used as a pigment, superior result tends to be obtained in respect to a long-term storability and so on. This is supposed to be due to a difficulty of a self-dispersing pigment in water from the influence of other additives. In addition, when a self-dispersing pigment in water is used, macromolucule materials such as a macromolecule dispersant may be contained in ink.

The amount of pigment that is used is from about 0.5 to 20% by mass, preferably from about 1 to 10% by mass, based on the amount of ink. If the amount of pigment in the ink is less than about 0.5% by mass, a sufficient optical density cannot be obtained in some cases, and if the amount of pigment exceeds about 20% by mass, ejection characteristics of the ink sometimes become unstable.

To the ink may be added a macromolecule dispersant for the purpose of dispersion of the pigment. When a self-dispersing pigment in water is used, a macromolecule dispersant may also be added as a macromolecule material. The macromolecule dispersants that may be utilized include a nonionic compound, an anionic compound, cationic compound and an amphoteric compound, the examples that may be used including copolymers of monomers having an α, β-ethylene-based unsaturated group.

Specific examples of monomers having an α, β-ethylene-based unsaturated group include acrylic acid, methacrylic acid, crotonic acid, itaconic acid, an itaconic acid monoester, maleic acid, a maleic acid monoester, fumaric acid, a fumaric acid monoester, vinylsulfonic acid, styrenesulfonic acid, sulfonated vinylnaphthalene, vinyl alcohol, acrylamide, methacryloxyethyl phosphate, bismethacryloxyethyl phosphate, methacryloxyethylphenyl phosphate, ethylene glycol dimethacrylate, diethylene glycohol dimethacrylate, styrene, □-methylstyrene, styrene derivatives such as vinyltoluene, vinylcylohexane, vinylnapththalene, a vinylnaphthalene derivative, an acrylic acid alkylester, an acrylic acid phenylester, a methacrylic acid alkylester, a methacrylic acid phenylester, a methacrylic acid cycloalkylester, a crotonic acid alkylester, an itaconic acid dialkylester, and maleic acid dialkylester.

A copolymer obtained by the copolymerization of a single or a plurality of the above monomers having an α, β-ethylene-based unsaturated group is used as a macromolecule dispersant. The specific examples include polyvinyl alcohol, polyvinyl pyrrolidone, a styrene-styrene sulfonate copolymer, a styrene-maleic acid copolymer, a styrene-methacrylic acid copolymer, a styrene-acrylic acid copolymer, a vinylnaphthalene-maleic acid copolymer, a vinylnaphthalene-methacrylic acid copolymer, a vinylnaphthalene-acrylic acid copolymer, an acrylic acid alkyl ester-acrylic acid copolymer, a methaacrylic acid alkyl ester-methacrylic acid, a styrene-methacrylic acid alkylester-methacrylic acid copolymer, a styrene-acrylic acid alkylester-acrylic acid copolymer, a styrene-methacrylic acid phenylester-methacrylic acid copolymer, and a styrene-methacrylic acid cyclohexylester-methacrylic acid copolymer.

The high molecular dispersant is preferred to be 2000 to 15000 in weight-average molecular weight. If the molecular weight of the high molecular dispersant is less than 2000, the pigment may not disperse stably, or if the molecular weight exceeds 15000, the ink viscosity is high and the ejecting performance may be worsened. A more preferable weight-average molecular weight is 3500 to 10000.

The macromolecule dispersant is suitably added in the range of from about 0.1 to 3% by mass based on the ink. When the amount of addition exceeds about 3% by mass, the ink viscosity becomes high and ejection characteristics of the ink become unstable in some cases. On the other hand, when the amount of addition is below about 0.1% by mass, the dispersion stability of the pigment is sometimes decreased. The amount of addition as a macromolecule dispersant is more preferably from about 0.15 to 2.5% by mass, still more preferably from about 0.2 to 2% by mass.

Water-soluble organic solvents contained in the ink include polyalcohols, polyalcohol derivatives, nitrogen-containing solvents, alcohols, and sulfur-containing solvents. Specific examples of the polyalcohols include ethylene glycol, diethylene glycol, propylene glycol, butylene glycol, triethylene glycol, 1,5-pentanediol, 1,2,6-hexanetriol, and glycerin. Specific examples of the polyalcohol derivatives include ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, and ethylene oxide adducts of diglycerin. Specific examples of the nitrogen-containing solvents include pyrrolidone, N-methyl-2-pyrrolidone, cyclohexylpyrrolidone, and triethanolamine. Specific examples of the alcohols include ethanol, isopropyl alcohol, butyl alcohol, and benzyl alcohol. Specific examples of the sulfur-containing solvents include thiodiethanol, thiodiglycerol, sulfolane, and dimethylsulfoxide. Additionally, propylene carbonate, ethylene carbonate, and the like may also be employed.

For water-soluble organic solvents, at least one species is preferably used. The content of water-soluble organic solvent that is used is from about 1 to 60% by mass, preferably from about 5 to 40% by mass. If the amount of water-soluble organic solvent in the ink is below about 1% by mass, a sufficient optical density cannot sometimes be obtained, and if the amount is more than about 60% by mass, the ink viscosity sometimes becomes large, leading to unstable ejection characteristics of the ink.

The ink may contain a surfactant. As a surfactant, a compound and the like may be used that has a structure having both a hydrophilic portion and a hydrophobic portion in the molecule, and surfactants that may be used include anionic surfactants, cationic surfactants, amphoteric surfactants and nonionic surfactants. Moreover, the aforementioned macromolecule dispersant may be used as a surfactant as well.

The anionic surfactant includes alkyl benzene sulfonate, alkyl phenyl sulfonate, alkyl naphthalene sulfonate, higher fatty acid salt, ester sulfate of higher fatty acid ester, sulfonate of higher fatty acid ester, ester sulfate and sulfonate of higher alcohol ether, higher alkyl sulfosuccinate, higher alkyl ester phosphate, and ester phosphate of higher alcohol ethylene oxide adduct, and specific examples include dodecyl benzene sulfonate, keryl benzene sulfonate, isopropyl naphthalene sulfonate, monobutyl phenyl phenol monosulfonate, monobutyl phenyl sulfonate, monobutyl biphenyl sulfonate, and dibutyl phenyl phenol disulfonate.

The nonionic surfactant includes, for example, polypropylene glycol ethylene oxide adduct, polyoxyethylene nonyl phenyl ether, polyoxyethylene octyl phenyl ether, polyoxyethylene dodecyl phenyl ether, polyoxyethylene alkyl ether, polyoxyethylene fatty acid ester, sorbitan fatty acid ester, polyoxyethylene sorbitan fatty acid ester, fatty acid alkylol amide, acetylene glycol, oxyethylene adduct of acetylene glycol, fatty acid alkanol amide, glycerin ester, and sorbitan ester.

The cationic surfactant includes tetra-alkyl ammonium salt, alkylamine salt, benzalkonium salt, alkyl pyridium salt, and imidazolium salt, and specific examples include dihydroxy ethyl stearyl amine, 2-heptadecenyl-hydroxy ethyl imidazoline, lauryl dimethyl benzyl ammonium chloride, cetyl pyridium chloride, and stearamide methyl pyridium chloride.

Other examples include silicone surfactants such as polysiloxane oxyethylene adduct, fluorine surface active agents such as perfluoroalkyl carbonate, perfluoroalkyl sulfonate, and oxyethylene perfluoroalkyl ether, and also biosurfactants such as spiculisporic acid, rhamnolipid and lysolecithin.

Among these, nonionic surfactants are preferable from the standpoint of dispersion stability of the pigment. From the standpoint of permeability control, acetylene glycol, oxyethylene adducts of acetylene glycol, polyoxyethylene alkyl ether, and the like are more preferable.

The amount of addition of the surfactant is preferably used in the range of below about 10% by mass, more preferably in the range of from about 0.01 to 5% by mass, still more preferably in the range of from about 0.01 to 3% by mass, based on the ink. If the amount of addition is about 10% by mass or more, the optical density and self stability of the pigment ink are sometimes deteriorated.

The ink may also contain other additives for the purpose of controlling the characteristics, such as ink ejection improvement, including polyethylene imine, polyamines, polyvinyl pyrrolidone, polyethylene glycol, ethyl cellulose, carboxymethyl cellulose, other cellulose derivatives, polysaccharide and its derivatives, other water-soluble polymers, acrylic polymer emulsion, polyurethane emulsion, other polymer emulsions, cyclodextrin, large cyclic amines, dendrimer, crown ether, urea and its derivatives, and acetamide. Further, to adjust the conductivity or pH, various compounds may be added, including compounds of alkaline metals such as potassium hydroxide, sodium hydroxide and lithium hydroxide, compounds containing nitrogen such as ammonium hydroxide, triethanol amine, diethanol amine, ethanol amine and 2-amino-2-methyl-1-propanol, compounds of alkaline earth metal such as calcium hydroxide, acids such as sulfuric acid, hydrochloric acid and nitric acid, salts of strong acid and weak alkaline such as ammonium sulfate.

As required, moreover, other useful additives include pH buffer, antioxidant, antifungal agent, viscosity adjusting agent, conductive agent, ultraviolet absorbent, and chelating agent.

The aforementioned treating liquid may contain at least one of a component that causes the pigment in an ink to be aggregated. Specifically, for example, for an ink containing a pigment having an anionic group, an electrolyte, a cationic compound and the like may be contained in the treating liquid. The electrolytes that are effectively used in the invention include alkaline metal ions such as lithium ions, sodium ions, and potassium ions, polyvalent metal ions such as aluminum ions, barium ions, calcium ions, copper ions, iron ions, magnesium ions, manganese ions, nickel ions, tin ions, titanium ions, and zinc ions, and salts of hydrochloric acid, bromic acid, hydroiodic acid, sulfuric acid, nitric acid, phosphoric acid, thiocyanic acid, and organic carboxylic acids such as acetic acid, oxalic acid, lactic acid, fumaric acid, citric acid, salicylic acid, and benzoic acid, and organic sulfonic acids.

Specific examples of the electrolytes include salts of alkaline metals such as lithium chloride, sodium chloride, potassium chloride, sodium bromide, potassium bromide, sodium iodide, potassium iodide, sodium sulfate, potassium nitrate, sodium acetate, potassium oxalate, sodium citrate, and potassium benzoate, and salts of polyvalent metals such as aluminum chloride, aluminum bromide, aluminum sulfate, aluminum nitrate, aluminum sodium sulfate, aluminum potassium sulfate, aluminum acetate, barium chloride, barium bromide, barium iodide, barium oxide, barium nitrate, barium thioantimonate, calcium chloride, calcium bromide, calcium iodide, calcium nitrite, calcium nitrate, calcium dihydrogenphosphate, calcium thiocyanate, calcium benzoate, calcium acetate, calcium salicylate, calcium tartrate, calcium lactate, calcium fumarate, calcium citrate, copper chloride, copper bromide, copper sulfate, copper nitrate, copper acetate, iron chloride, iron bromide, iron iodide, iron sulfate, iron nitrate, iron oxalate, iron lactate, iron fumarate, iron citrate, magnesium chloride, magnesium bromide, magnesium iodide, magnesium sulfate, magnesium nitrate, magnesium acetate, magnesium lactate, manganese chloride, manganese sulfate, manganese nitrate, manganese dihydrogenphosphate, manganese acetate, manganese salicylate, manganese benzoate, manganese lactate, nickel chloride, nickel bromide, nickel sulfate, nickel nitrate, nickel acetate, tin sulfate, titanium chloride, zinc chloride, zinc bromide, zinc sulfate, zinc nitrate, zinc thiocyanate, and zinc acetate.

On the other hand, the cationic compounds include primary, secondary, tertiary, and quaternary amines and salts thereof. The specific examples include tetraalkylammonium salts, alkylamine salts, benzalkonium salts, alkylpyridinium salts, imidazolium salts, and polyamines; the examples include isopropylamine, isobutylamine, t-butylamine, 2-ethylhexylamine, nonylamine, dipropylamine, diethylamine, trimethylamine, triethylamine, dimethylpropylamine, ethylenediamine, propylenediamine, hexamethyldiamine, diethylenetriamine, tetraethylenepentamine, diethanolamine, diethylethanolamine, triethanolamine, tetramethylammonium chloride, tetraethylammonium bromide, dihydroxyethylsteallylamine, 2-heptadecenyl-hydroxyethylimidazoline, lauryldimethylbenzylammonium chloride, cetylpyridinium chloride, stearamidemethylpyridinium chloride, diallyldimethylammonium chloride polymers, diallylamine polymers and monoallylamine polymers.

Preferable electrolytes include ammonium sulfate, calcium chloride, calcium nitrate, calcium acetate, magnesium chloride, magnesium nitrate, magnesium sulfate, magnesium acetate, tin sulfate, zinc chloride, zinc nitrate, zinc sulfate, zinc acetate, ammonium nitrate, monoallylamine polymers, diallylamine polymers, and diallyldimethylammonium chloride polymers.

On the other hand, for an ink containing a pigment having a cationic group on the surface thereof, the treating liquid may be made to contain an anionic compound and the like. Anionic compounds that are effectively used in the invention include organic carboxylic acids or organic sulfonic acids and salts thereof. Specific examples of organic carboxylic acids include acetic acid, oxalic acid, lactic acid, fumaric acid, citric acid, salicylic acid and benzoic acid and oligomers and polymers, both having a plurality of the basic structures thereof may also be employed. Specific examples of organic sulfonic acids include compounds such as benzenesulfonic acid, and toluenesulfonic acid, and oligomers and polymers, both having a plurality of the basic structures thereof may also be employed.

For the treating liquid, the above compounds may be used alone or in combination with two or more species. The content of the above compound that may be used in a treating liquid is preferably from 0.1 to 15% by weight, more preferably from 0.5 to 10% by weight.

A treating liquid may contain a surfactant as with an ink. Examples of the surfactant include compounds similar to the above substances.

The surface tension of an ink (including a treating liquid) is preferably from 20 mN/m or more to less than 60 mN/m, and more preferably from 22.5 mN/m or more to less than 40 mN/m. If the surface tension is below 20 mN/m, some liquid leaks on nozzle surfaces, thereby being incapable of normally printing an image in some cases. On the other hand, the surface tension exceeds 60 mN/m, the permeability becomes slow, thereby sometimes decreasing the drying time.

The surface tension can be determined under conditions of 23° C. and 55% RH by use of a surface tension balance (CVBP-Z, manufactured by Kyowa Interface Co., Ltd.).

The viscosity of an ink (including a treating liquid) is preferably from 1.2 mPa·s or more to less than 8.0 mPa·s, and more preferably from 1.5 mPa·s or more to less than 6.0 mPa·s. If the viscosity is less than 1.2 mPa·s, reliability for long period of time sometimes worsens. On the other hand, if the viscosity exceeds 8.0 mPa·s, discharge properties lower in some cases.

The viscosity can be determined by TVE-20L (manufactured by Toki Sangyo Co., Ltd.) as a measuring apparatus. At this time, conditions were set to be at measuring temperature of 23° C. and at a shear rate of 750 s⁻¹.

Next, the operation of the ink jet recording device 10 having the above-mentioned structure is explained.

During a printing operation, paper is fed from the paper feeding portion 12. The position and timing of the paper is controlled by the registration adjusting portion 14, and the paper is conveyed to the recording portion 16.

At the recording portion 16, a motor (not depicted) is driven and the driving force therefrom is transmitted to all of the conveying rolls 40 via a plane belt.

The paper that has arrived at the recording portion 16 is then inserted between the conveying roll 40 and the star wheel 42 located furthest toward the upstream side in the conveying direction. During this operation, the star wheel 42 urged by a spring (not depicted) presses the paper to the conveying roll 40, whereby conveying force is transmitted, with certainty, from the conveying roll 40 to the paper. The driving force is transmitted from the conveying rolls 40 provided between the recording heads 28 at a constant rate, whereby the paper is conveyed.

When a printing signal is input from the controlling portion of the device to the recording heads 28, the heat generating elements of the nozzles generate heat in response to the printing signal and ink is ejected from the nozzles to the paper while the paper is conveyed with a distance to the nozzle surface being kept constant.

Conduct of printing by the recording heads 28 causes the printing of the fraction of one color on the portion of a paper sheet to be printed in the maximum recording region of the paper sheet, leading to the completion. In this manner, a paper sheet is printed by the recording head 28T, 28K, 28C, 28M and 28Y in the order as the paper sheet is transported in the recording portion 16, resulting in a full color of printing.

As the ink printed with each printing head 28C to 28Y is printed on the treating liquid printed with print head 28T, the pigments contained in the ink are largely coagulated with the treating liquid.

Next, the liquid absorbing device 34 disposed upstream of each recording head absorbs each of the excess liquid of the color inks remaining on the paper sheet (absorbing action).

The paper on which an image has been printed with the ink arrives at the paper ejecting portion 18 and is loaded into the tray 38 via the paper ejecting belt 36.

In this way, in the embodiment, the extra liquid of printing liquids is absorbed by means of the liquid absorbing device 34 as a liquid absorbing mechanism by utilization of a porous body. Hydrophobicity of the porous body inhibits gelation even though the porous body absorbs the excess liquid, as well as preventing the adhesion of ink to a paper sheet and the disturbance of an image. This mechanism reliably absorbs the excess liquid of ink impacted on a paper sheet to sufficiently improve the offset of ink, curl, cockle, and drying properties, being capable of obtaining a good image.

In the embodiment, the paper sheet uses impermeable media (e.g., OHP) in addition to ordinary paper. Besides ordinary paper, even use of impermeable media that are extremely poor in permeability of the excess liquid reliably absorbs the excess liquid of printing liquids impacted on a sheet, being able to obtain a good image.

Also, in the embodiment, the construction that causes the recording heads 28 and the liquid absorbing device 34 to have printing regions (absorbing region) corresponding to the maximum paper width PW of a paper sheet makes it possible to print the entire width of the paper sheet without scanning of the recording heads 28, thereby making no differences of drying and permeation of printing liquid (ink or treating liquid) impacted on the paper sheet. In this state, the liquid absorbing device 34 can absorb the excess liquid of the printing liquid, so the curl, cockle and drying properties can be improved more effectively.

In addition, embodiments of the invention can be applied to a printing device in which unit recording heads (short heads) are arranged in the width direction of the paper.

### EXAMPLES

Hereinafter, the present invention is more specifically explained with reference to Examples. However, the invention is not limited to the Examples.

### Example 1

(Ink)

A water-soluble organic solvent, a surfactant, ion exchanged water, a coloring agent solution and so forth are blended so as to become the specified composition below, and the resulting solution is agitated and mixed. The resultant liquid is passed through a filter of 5 μm to obtain an ink. The viscosity of this ink is 3.6 mPa·s; the surface tension is 31 mN/m.

Composition

Pigment (Mogul L (5% by mass), manufactured by Cabot Corp.)

Styrene-acrylic acid-sodium acrylate copolymer (0.6% by mass)

Diethylene glycol (1% by mass)

Olfine E1010 (1% by mass), manufactured by Nissin Chemical Industry Co., Ltd.

Water (balance)

(Powder)

Powder 1

With a water-insoluble monomer primarily made of methyl methacrylate is as appropriate selected and mixed with a solvent that does not dissolve the above monomer to prepare a polymerization solution. Use of the polymerization solution gives by emulsion polymerization a hydrophobic porous body, Powder 1. Properties of the powder are tabulated in Table 1.

Powder 2

With a water-insoluble monomer primarily made of methyl methacrylate is as appropriate selected and mixed with a solvent that does not dissolve the above monomer in a blending ratio different from preparation of Powder 1 to prepare a polymerization solution. Use of the polymerization solution gives by emulsion polymerization a hydrophobic porous body, Powder 2. Properties of the powder are tabulated in Table 1.

Powder 3

With a water-insoluble monomer primarily made of methyl methacrylate is as appropriate selected and mixed with a solvent that does not dissolve the above monomer to prepare a polymerization solution. Use of the polymerization solution gives by emulsion polymerization a hydrophobic porous body, Powder 3. Properties of the powder are tabulated in Table 1.

Powder 4

With a water-insoluble monomer primarily made of methyl methacrylate is as appropriate selected and mixed with a solvent that does not dissolve the above monomer to prepare a polymerization solution. Use of the polymerization solution gives by emulsion polymerization a hydrophobic porous body, Powder 4. Properties of the powder are tabulated in Table 1.

Powder 5

With a water-insoluble monomer primarily made of methyl methacrylate is as appropriate selected and mixed with a solvent that does not dissolve the above monomer to prepare a polymerization solution. Use of the polymerization solution gives by emulsion polymerization a hydrophobic porous body, Powder 5. Properties of the powder are tabulated in Table 1.

Powder 6

With a water-insoluble monomer primarily made of methyl methacrylate is as appropriate selected and mixed with a solvent that does not dissolve the above monomer to prepare a polymerization solution. Use of the polymerization solution gives by emulsion polymerization a hydrophobic porous body, Powder 6. Properties of the powder are tabulated in Table 1.

Powder 7

A water-insoluble monomer primarily made of methyl methacrylate is subjected to emulsion polymerization to yield hydrophobic particulates, Powder 7. Properties of the powder are tabulated in Table 1.

Powder 8

Acrylic acid and sodium hydroxide are subjected to granular polymerization to yield a powder, Powder 8. Properties of the powder are tabulated in Table 1.

Powder 9

With a water-insoluble monomer primarily made of methyl methacrylate is as appropriate selected and mixed with a solvent that does not dissolve the above monomer to prepare a polymerization solution. Use of the polymerization solution gives by emulsion polymerization a hydrophobic porous body, Powder 9. Properties of the powder are tabulated in Table 1.

Powder 10

With a water-insoluble monomer primarily made of methyl methacrylate is as appropriate selected and mixed with a solvent that does not dissolve the above monomer to prepare a polymerization solution. Use of the polymerization solution gives by emulsion polymerization a hydrophobic porous body, Powder 10. Properties of the powder are tabulated in Table 1.

### Examples 1-1 to 1-8, and Comparative Examples 1-1 and 1-2

The above ink is placed in a testing printer and a solid pattern and words are printed on a paper sheet (coated paper OK Kinfuji N, manufactured by Oji Paper Co., Ltd.) in terms of 1440×720 dpi, and then on the paper sheet is sprinkled a powder in accordance to Table 1; the power is removed with a brush. This printed material is subjected to evaluation of curl and cockle, image conditions, and powder removal properties. The evaluation methods are in the following. The results are summarized in Table 1.

Curl and Cockle

A recording material to be printed is placed on a flat surface and the four ends of the paper sheet are determined for the heights from the surface. The evaluation criteria are as follows:

a: the height is 5 mm or less

b: the height is more than 5 mm and less than 6 mm

c: the height is 6 mm or more

Image Conditions

The image conditions are visually judged on the basis of the evaluation criteria below:

a: the image has no distortion and is good

b: the image has no distortion; however, the image density is low

c. the image has distortion

Powder Removed State

The powder removed state was visually judged on the basis of the evaluation criteria below.

a: the powder is removed, and the coloring material does not come off

b: the powder is removed; however, the coloring material slightly comes off

c: the powder remains

TABLE 1

| | Powder | | | | | | | |
|---|---|---|---|---|---|---|---|---|
| | | | Average | Amount of | Pore | Curl | | Powder |
| | | | particle | liquid absorption | diameter | and | Image | removed |
| | Number | Kind of material | diameter (μm) | (ml/g) | (nm) | cockle | conditions | state |
| Example | 1 | Crosslinked methyl | 8 | 1.4 | 20 | a | a | a |
| 1-1 | | methacrylate | | | | | | |
| Example | 2 | Crosslinked methyl | 5 | 1 | 20 | a | a | a |
| 1-2 | | methacrylate | | | | | | |
| Example | 3 | Crosslinked methyl | 50 | 10 | 100 | a | b | a |
| 1-3 | | methacrylate | | | | | | |
| Example | 4 | Crosslinked methyl | 1 | 1 | 20 | a | a | b |
| 1-4 | | methacrylate | | | | | | |
| Example | 5 | Crosslinked methyl | 100 | 100 | 100 | a | b | a |
| 1-5 | | methacrylate | | | | | | |
| Example | 6 | Crosslinked methyl | 5 | 1.3 | 10 | a | a | a |
| 1-6 | | methacrylate | | | | | | |
| Comparative | 7 | Crosslinked methyl | 8 | — | — | c | b | c |
| Example 1-1 | | methacrylate | | | | | | |
| | | (non-porous) | | | | | | |
| Comparative | 8 | Sodium acrylate | 30 | 200 | — | a | c | c |
| Example 1-2 | | polymer (material | | | | | | |
| | | partially crosslinked | | | | | | |
| | | by a sodium salt) | | | | | | |
| Example 1-7 | 9 | Crosslinked methyl | 100 | 100 | 150 | a | b | a |
| | | methacrylate | | | | | | |
| Example 1-8 | 10 | Crosslinked methyl | 0.5 | 0.5 | 5 | b | b | b |
| | | methacrylate | | | | | | |

The results of Table 1 show that sprinkling and subsequent removal of hydrophobic porous particles as powder on a paper sheet after printing readily remove the excess liquid of an ink without its adherence on the paper sheet while sufficiently absorbing the excess liquid and cause no disturbance of the image.

### Example 2

(Liquid Absorbing Roll (Liquid Absorbing Apparatus of a Roll Mode))

Liquid Absorbing Roll 1

A core material having hydrophilic porous polyurethane (absorbing body layer) provided on the outer periphery thereof has a surface absorption layer with a thickness of 5 μm provided on the outer periphery of the hydrophilic porous polyurethane. This surface absorption layer is formed by a procedure that involves kneading a PET material with a hydrophobic porous powder to form a sheet, and then adhering the sheet to the outer periphery of the porous polyurethane. The resulting article is used as Liquid Absorbing Roll 1. The properties of the roll are shown in Table 2.

Liquid Absorbing Roll 2

Liquid Absorbing Roll 2 is fabricated as in Liquid Absorbing Roll 1 with the exception that the surface absorbing layer is formed by a procedure that involves coating a substrate of PET film with a mixture of a coating material and a hydrophobic porous powder and then adhering the resulting material to the outer periphery of the porous polyurethane. The properties of the roll are tabulated in Table 2.

Liquid Absorbing Roll 3

Liquid Absorbing Roll 3 is fabricated as in Liquid Absorbing Roll 1 with the exception that the surface absorption layer is adhered to the outer periphery of porous polyurethane by use of a sheet fiber produced by adherence of a hydrophobic porous powder to the surface of an acrylic fiber. The properties of the roll are tabulated in Table 2.

Liquid Absorbing Roll 4

Liquid Absorbing Roll 4 is fabricated as in Liquid Absorbing Roll 1 with the exception that another hydrophobic porous powder with which the PET material is kneaded. The properties of the roll are tabulated in Table 2.

Liquid Absorbing Roll 5

Liquid Absorbing Roll 5 is fabricated as in Liquid Absorbing Roll 1 with the exception that other hydrophobic porous powder with which the PET material is kneaded. The properties of the roll are tabulated in Table 2.

Liquid Absorbing Roll 6

Liquid Absorbing Roll 5 is fabricated as in Liquid Absorbing Roll 1 with the exception that other hydrophobic porous powder with which the PET material is kneaded. The properties of the roll are tabulated in Table 2.

Liquid Absorbing Roll 7

Liquid Absorbing Roll 7 is fabricated by a procedure that involves preparing a core material having hydrophilic porous polyurethane (absorbing body layer) provided on the outer periphery thereof, and subsequently adhering no surface absorption layer containing a hydrophobic porous body to the outer periphery of the hydrophilic porous polyurethane. The properties of the roll are tabulated in Table 2.

Liquid Absorbing Roll 8

Liquid Absorbing Roll 8 is fabricated as in Liquid Absorbing Roll 1 with the exception that with the surface absorption layer is coated a mixture of a coat material that uses PET film as a substrate and a powder of a sodium acrylate polymer (material partially crosslinked by a sodium salt) and the resulting material is adhered to the outer periphery of porous polyurethane. The properties of the roll are tabulated in Table 2.

Liquid Absorbing Roll 9

Liquid Absorbing Roll 9 is fabricated as in Liquid Absorbing Roll 1 with the exception that other hydrophobic porous powder with which the PET material is kneaded. The properties of the roll are tabulated in Table 2.

Liquid Absorbing Roll 10

Liquid Absorbing Roll 10 is fabricated as in Liquid Absorbing Roll 1 with the exception that other hydrophobic porous powder with which the PET material is kneaded. The properties of the roll are tabulated in Table 2.

### Examples 2-1 to 2-8, and Comparative Examples 2-1 and 2-2

An ink having the same composition as Example 1-1 is placed in a testing printer and a solid pattern and words are printed on a paper sheet (coated paper OK Kinfuji N, manufactured by Oji Paper Co., Ltd.) in terms of 1440×720 dpi, and then the extra liquid of ink is absorbed by a liquid absorbing roll in accordance to Table 1. This printed material is subjected to evaluation of curl and cockle, and image conditions. The evaluation methods are the same as with Example 1-1. The results are summarized in Table 2.

TABLE 2

| | Liquid absorbing roll (surface | | | | | |
|---|---|---|---|---|---|---|
| | absorption layer construction) | | | | | |
| | | | Amount | | | |
| | | | of liquid | Pore | | |
| | | | absorption | diameter | Curl and | Image |
| | Number | Kind of material | (ml/g) | (nm) | cockle | conditions |
| Example 2-1 | 1 | Crosslinked methyl methacrylate | 1.4 | 20 | a | a |
| Example 2-2 | 2 | Crosslinked methyl methacrylate | 1.4 | 20 | a | a |
| Example 2-3 | 3 | Crosslinked methyl methacrylate | 1.4 | 20 | a | a |
| Example 2-4 | 4 | Crosslinked methyl methacrylate | 1 | 10 | a | a |
| Example 2-5 | 5 | Crosslinked methyl methacrylate | 10 | 50 | a | a |
| Example 2-6 | 6 | Crosslinked methyl methacrylate | 100 | 100 | a | a |
| Comparative | 7 | None | None | None | a | c |
| Example 2-1 | | | | | | |
| Comparative | 8 | Sodium acrylate polymer | 200 | — | a | c |
| Example 2-2 | | (material partially crosslinked by a | | | | |
| | | sodium salt) | | | | |
| Example 2-7 | 9 | Crosslinked methyl methacrylate | 0.5 | 20 | b | b |
| Example 2-8 | 10 | Crosslinked methyl methacrylate | 1.4 | 5 | b | b |

The results of Table 2 show that the use of the liquid absorbing roll provided with the hydrophobic porous body layer as the surface absorption layer readily removes the excess liquid of an ink without its adherence on the paper sheet while sufficiently absorbing the excess liquid and cause no disturbance of the image.

What is claimed is:

1. An ink jet recording apparatus comprising:
a recording head that causes printing liquid to impact on a recording medium, and a liquid absorbing mechanism that absorbs excess liquid of the printing liquid remaining on the recording medium after the printing liquid is impacted on the recording medium by means of the recording head, wherein the liquid absorbing mechanism makes a hydrophobic porous body come into contact with the printing liquid for the purpose of absorbing the excess liquid of the printing liquid by means of the hydrophobic porous body.

2. The ink jet recording apparatus of claim 1, wherein a pore diameter of the hydrophobic porous body is from 10 to 100 nm.

3. The ink jet recording apparatus of claim 1, wherein an amount of absorption of the hydrophobic porous body is from 1 to 100 ml/g.

4. The ink jet recording apparatus of claim 1, wherein the hydrophobic porous body comprises a polymer produced by using of a water-insoluble monomer as a starting material.

5. The ink jet recording apparatus of claim 1, wherein:
the liquid absorbing mechanism comprises an absorber having a surface layer that makes contact with the excess liquid; and
the surface layer comprises the hydrophobic porous body.

6. The ink jet recording apparatus of claim 1, wherein:
the liquid absorbing mechanism comprises an absorber having a surface layer that makes contact with the excess liquid; and
the surface layer comprises a laminar body of the hydrophobic porous body.

7. The ink jet recording apparatus of claim 1, wherein:
the liquid absorbing mechanism comprises an absorber having a surface layer that makes contact with the excess liquid; and
the surface layer comprises a resin layer having a granular body of the hydrophobic porous body embedded in the surface thereof.

8. The ink jet recording apparatus of claim 7, wherein an average particle diameter of the granular hydrophobic porous body is from 1 to 100 μm.

9. The ink jet recording apparatus of claim 1, wherein the liquid absorbing mechanism comprises a sprinkling unit for sprinkling a granular body of the hydrophobic porous body on the recording medium, and a removing unit for removing the granular hydrophobic porous body sprinkled on the recording medium.

10. The ink jet recording apparatus of claim 9, wherein an average particle diameter of the granular hydrophobic porous body is from 1 to 100 μm.

11. The ink jet recording apparatus of claim 1, wherein the recording medium comprises ordinary paper or an impermeable medium.

12. The ink jet recording apparatus of claim 1, wherein the liquid absorbing mechanism comprises a roll-type liquid absorbing mechanism.

13. The ink jet recording apparatus of claim 1, wherein the liquid absorbing mechanism comprises a belt mode liquid absorbing mechanism.

14. The ink jet recording apparatus of claim 1, wherein the liquid absorbing mechanism comprises a web mode liquid absorbing mechanism.

15. An ink jet recording method comprising:
causing a recording head to impact printing liquid upon a recording medium; and
absorbing excess liquid of the printing liquid remaining on the recording medium by means of a liquid absorbing mechanism,
wherein the liquid absorbing mechanism makes a hydrophobic porous body come into contact with the printing liquid for the purpose of absorbing the excess liquid of the printing liquid by means of the hydrophobic porous body.

16. The ink jet recording method of claim 15, wherein a pore diameter of the hydrophobic porous body is from 10 to 100 nm.

17. The ink jet recording method of claim 15, wherein an amount of absorption of the hydrophobic porous body is from 1 to 100 ml/g.

18. The ink jet recording method of claim 15, wherein the hydrophobic porous body comprises a polymer produced by using of a water-insoluble monomer as a starting material.

19. The ink jet recording method of claim 15, wherein:
the liquid absorbing mechanism comprises an absorber having a surface layer that makes contact with the excess liquid; and
the surface layer comprises the hydrophobic porous body.

20. The ink jet recording method of claim 15, wherein the liquid absorbing mechanism comprises a sprinkling unit for sprinkling a granular body of the hydrophobic porous body on the recording medium, and a removing unit for removing the granular hydrophobic porous body sprinkled on the recording medium.
